(19) United States
(12) Patent Application Publication
(10) Pub. No.: US 2023/0368099 A1
(43) Pub. Date: Nov. 16, 2023

(54) Operation Plan Creation Device and Operation Plan Creation Method in Data Center

(71) Applicant: Hitachi, Ltd., Tokyo (JP)

(72) Inventors: Hiro TANAKA, Tokyo (JP); Atsuya KUMAGAI, Tokyo (JP); Yoji OZAWA, Tokyo (JP)

(21) Appl. No.: 18/142,077

(22) Filed: May 2, 2023

(30) Foreign Application Priority Data
May 10, 2022 (JP) 2022-077762

(51) Int. Cl. G06Q 10/0631; G06Q 10/04

(52) U.S. Cl. CPC G06Q 10/06316; G06Q 10/04

(57) ABSTRACT

The invention achieves an increase in speed and optimization of a cooperative operation plan creation work between a data center operator and a user. In an operation plan creation method in a data center, an operation plan server calculates a handling cost to handle a given consumption pattern of a DC user when an operation plan of a created workload (WL) is to be created or changed, and creates an operation plan optimization equation for maximizing or minimizing an index such as a cost including the handling cost. At this time, a solution of the operation plan optimization equation is obtained such that a consumption pattern obtained by changing a consumption pattern in a past response history of the user according to a certain rule is available at a handling cost to handle the changed consumption pattern, thereby creating an operation plan draft for the consumption pattern of the user and a device held by a data center operator. The operation plan server confirms, to a WL execution management server, whether the operation plan draft can be executed, and instructs the WL execution management server to execute the operation plan draft.

### BACKGROUND OF THE INVENTION

### 1. Field of the Invention

The present invention relates to an operation plan creation device and an operation plan creation method using a hierarchical operation plan optimization technique for creating, at a high speed, an operation plan including a negotiation in a data center.

### 2. Description of Related Art

As a countermeasure against a climate change, introduction of renewable energy rapidly progresses together with effective use of energy. Since an output of the renewable energy changes depending on a weather condition, it may be difficult to adjust a power generation amount according to a power consumption. Therefore, it is important to make demand and supply coincide with each other by using adjustability such as use of a storage battery and a demand change. A power transmission and distribution operator, a microgrid operator, or a power retailer requires these adjustability for purposes of stable supply of a power and avoidance of imbalance. A consumer or a distributed energy resource (hereinafter, referred to as a “DER”) operator requires a profit due to provision of the adjustability and use of the renewable energy for de-carbonization. A cooperative operation for performing power interchange between these operators is required.

The cooperative operation is promising for a data center (hereinafter, also referred to as “DC”), which is one of the consumers using a large amount of power energy, from viewpoints that a power consumption is large, and the demand change is possible due to a change in an execution time and an execution site of a workload (hereinafter, also referred to as “WL” or “job”) executed by a server (hereinafter, also referred to as “WL shift”). Meanwhile, the workload executed in the data center (DC) not only includes a workload of a DC operator itself, but also includes a workload of a DC user who is an operator different from the DC operator. In a form other than the self-use in the data center, the workload of the DC user accounts for many cases, and the DC operator cannot directly control the cases. In order to effectively use adjustability of the data center, a cooperative operation between the DC operator and the DC user is required.

From viewpoints of cost and stability of power supply, efficient cooperative operation in the data center can be expected by creating an optimal cooperative operation plan between the DC operator and the DC user. However, since it is not preferable to disclose device information possessed by each operator and operation information thereof during creation of the cooperative operation plan, it is required to optimize the operation plan without disclosing the device information of each DC operator. JP2021-136757A discloses a method of creating an overall optimal operation plan, regarding creation of a cooperative operation plan between a power distribution system operator and a distributed energy resource (DER) operator or the like that has the DER, by separating a problem of minimizing an overall energy cost into a main problem that corresponds to determining a power generation amount of each operator by the power distribution system operation operator and a dependent problem that corresponds to determining control of a device possessed by each operator, and repeating the separation by alternately solving the problems while exchanging information such as the power generation amount and the energy cost.

In JP2021-136757A, it is possible to optimize an operation plan between operators having a two-layer relation in which, for example, one operation plan is a part of the other operation plan such as those between the power distribution system operator and the DER operator and between the DC operator and the DC user. However, the DC operator needs to establish a cooperative operation plan among operators having a three-layer relation, such as the DC operator, a DC user (in the data center) whose operation plan is a part of the operation plan of the DC operator, and a power transmission and distribution operator or a power retailer (outside the data center) whose operation plan includes the operation plan of the DC operator. In the optimization of the cooperative operation plan with the outside of the data center, replan is repeatedly required for the operation plan in the data center, and thus the optimization of the cooperative operation plan in the data center needs to be performed at a high speed in response to a replan request from the outside of the data center.

### SUMMARY OF THE INVENTION

The invention is made in view of such a background, and an object of the invention is to provide an operation plan creation device and an operation plan creation method capable of planning and replanning at a high speed in optimization of a cooperative operation plan between an operation plan control unit of a data center and a user of the data center.

In order to solve the above problem, the invention is applied to a data center that includes a plurality of server devices each configured to execute a workload, workload execution management servers respectively provided in the server devices, and an operation plan server connected to the workload execution management servers. A plurality of users use the server devices via a network. Each of the workload execution management servers manages execution of a workload (WL) of the user of the data center and includes a cost calculation unit configured to calculate a handling cost to handle a given power consumption in each time block (hereinafter, referred to as a consumption pattern). The operation plan server includes: an operation plan optimization problem creation unit configured to store the consumption pattern of the user and create an optimization problem for maximizing or minimizing an index such as a cost including the handling cost; an optimization equation update unit configured to update an operation plan optimization equation such that a consumption pattern obtained by changing a consumption pattern in a response history of the user according to a certain rule is available at a handling cost to handle the changed consumption pattern; and an operation plan draft calculation unit configured to create, by obtaining a solution of the updated operation plan optimization equation, an operation plan draft for the consumption pattern of the user and a device held by an operator. The cost calculation unit, the cooperative operation plan optimization problem creation unit, the optimization equation update unit, and the operation plan draft calculation unit can be implemented by software by executing, by processors of the workload execution management server or the operation plan server, specific computer programs for implementing these functions.

According to another aspect of the invention, the operation plan server compares the consumption pattern of the user with a corresponding consumption pattern base line of the user registered in advance, calculates, in each of the consumption patterns, a lower limit of a power consumption corresponding to an amount of an execution standby job queue in each time block, and updates, every time receiving a consumption pattern and a handling cost from the user, the operation plan optimization equation such that a consumption pattern that is achievable by advancing execution of a job queue calculated based on the consumption pattern (hereinafter, an early execution pattern) is available at a handling cost to handle the early execution pattern.

According to another aspect of the invention, when an operation plan of a created workload is to be created or changed, the operation plan server calculates a consumption pattern of each user of the server device and a handling cost thereof, creates an operation plan optimization equation for maximizing or minimizing an index of the handling cost in consideration of a consumption pattern of the user of the server device, updates the operation plan optimization equation such that a consumption pattern obtained by changing a consumption pattern in a past response history of the user according to a certain rule is available at a handling cost to handle the changed consumption pattern, and creates, by obtaining a solution of the updated operation plan optimization equation, an operation plan for the consumption pattern of the user and a device held by a data center operator.

According to the invention, the operation plan server can create, by creating an operation plan while negotiating with a workload (WL) execution management server about a consumption pattern of a data center (DC) user, a cooperative operation plan by which the power consumption of a data center is adjusted to approach a target without disclosing individual workload information of the data center user to a data center operator. In addition, by performing this adjustment, it is possible to minimize a total cost that is to be paid by the data center operator and includes a handling cost to be paid to the data center user. Further, the number of negotiations can be reduced, and replan can be performed at a high speed by considering, in the negotiation, early execution of a job whose execution is delayed in a consumption pattern proposed in the past.

Configurations and effects other than those described above will be clarified by description of the following embodiments.

### BRIEF DESCRIPTION OF THE DRAWINGS

FIG. 1 is a diagram showing an example of a configuration of an operation plan creation system according to an embodiment;

FIG. 2 is a diagram showing an example of hardware provided in an operation plan server 60 in FIG. 1 and functions thereof;

FIG. 3 is a diagram showing an example of a user management table 100 in FIG. 2;

FIG. 4 is a diagram showing an example of a response result management table 200 in FIG. 2;

FIG. 5 is a diagram showing an example of a consumption pattern base line management table 300 in FIG. 2;

FIG. 6 is a diagram showing an example of hardware provided in a WL execution management server 70 in FIG. 2 and functions thereof;

FIG. 7 is a diagram showing an example of a WL management table 500 in FIG. 6;

FIG. 8 is a diagram showing an example of a response history table 600 in FIG. 6;

FIG. 9 is a diagram showing an example of a consumption pattern of a DC user;

FIGS. 10A to 10E are diagrams showing an example of the same view of a consumption pattern change due to early execution and a cost;

FIG. 11 is a diagram showing an example of a first creation process for a cooperative operation plan;

FIG. 12 is a flowchart showing details of a cooperative operation plan optimization problem creation process in FIG. 11;

FIG. 13 is a flowchart showing details of a job queue calculation process in FIG. 11;

FIG. 14 is a flowchart showing details of an optimization equation update (to have cost same as early execution pattern) process in FIG. 11;

FIG. 15 is a flowchart showing details of a handling cost calculation process in FIG. 11;

FIG. 16 is a diagram showing an example of a management screen for a DC operator;

FIG. 17 is a diagram showing an example of a management screen for a DC user; and

FIG. 18 is a diagram showing an example of a second creation process for a cooperative operation plan.

### DESCRIPTION OF EMBODIMENTS

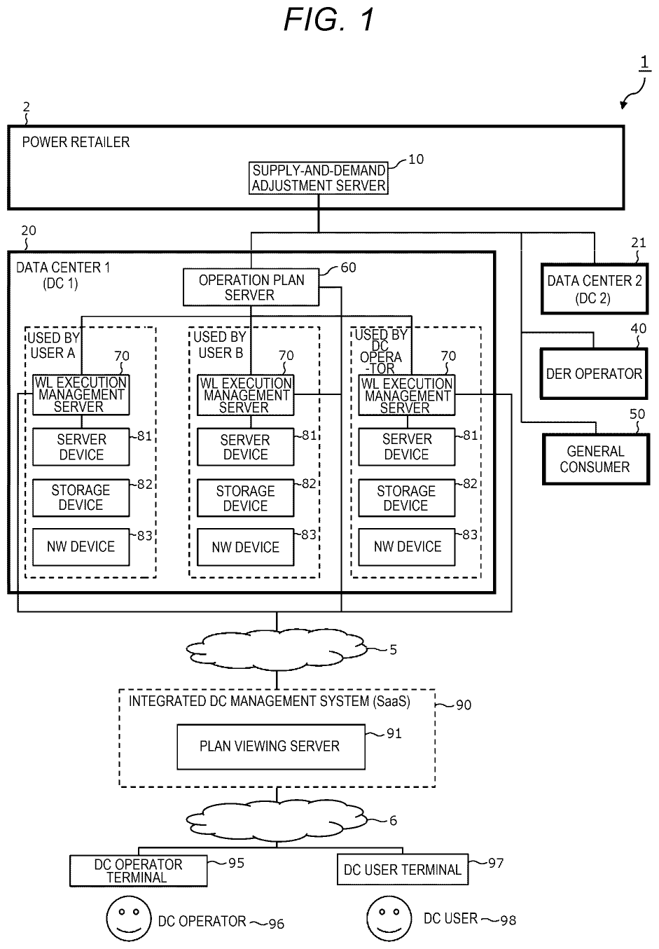

FIG. 1 is a diagram showing an example of an overall configuration of an operation plan creation system 1 according to an embodiment. The operation plan creation system 1 according to the invention includes a data center 20 and an integrated DC management system 90 connected to the data center 20 via a network 5. Power required for the data center 20 is supplied from a power retailer 2. An operation plan creation device according to the embodiment is provided in the data center 20. The data center 20 includes an operation plan server 60 and a WL execution management server 70 for each of DC users (a DC user A, a DC user B, and a DC operator). In addition, the data center 20 includes one or more server devices 81, storage devices 82, and NW (network) devices 83 for each of the DC operator and the DC users. The server device 81 is a device that executes a workload of the DC user. The WL execution management server 70 is a device that manages the execution of the workload in the server device 81. The NW device 83 is a known device such as a network switch. These facilities and devices operate while consuming power in relation to the workload (WL) executed by the server device 81.

A DC operator terminal 95 is an information processing device to be used by a DC operator 96 that manages the data center 20. A DC user terminal 97 is an information processing device to be used by a DC user 98 that uses the data center 20. Here, although only one DC user 98 is shown, a large number of users are actually present, and a plurality of DC user terminals 97 to be used by the users are connected to a network 6.

The integrated DC management system 90 includes a plan viewing server 91 as one element. The plan viewing server 91 acquires necessary information in the operation plan server 60 and the WL execution management server 70 via the networks 5 and 6 in response to an access from a user (the DC user or the like), and presents a plan viewing screen by the DC user terminal 97. The DC user terminal 97 can receive, from the plan viewing screen, an input instruction from the user, and transmit the input instruction to the integrated DC management system 90 and the data center 20 side. The integrated DC management system 90 is provided, for example, as Software as a Service (SaaS) to the DC operator 96 and the DC user 98. That is, the integrated DC management system 90 is accessed from the DC operator terminal 95 and the DC user terminal 97 via the network 6.

The power from the power retailer 2 is supplied to a second data center (DC2) 21, a DER operator 40, and a general consumer 50. The second data center 21 can be implemented by the same configuration as the first data center (DC1; that is, data center 20). In FIG. 1, only two data centers 20 and 21 are shown as data centers that receive the power supply from the power retailer 2, but a large number of data centers are actually present. A supply-and-demand adjustment server 10 is a computer provided in the power retailer 2, creates an operation plan of power based on a demand prediction, and performs power interchange by requesting the data centers 20 and 21, the DER operator 40, and the general consumer 50 to replan operation plans when a demand is necessary to be adjusted.

The operation plan server 60 drafts an operation plan for each server in the data center 20. That is, the operation plan server 60 divides a time period to be planned into several time blocks, and determines a control parameter of a device held by the DC operator 96 and a power consumption by each DC user 98 in each time block. In the embodiment, the operation plan is created in unit of 30 minutes as a length of the time block. The time block may have a unit not limited to 30 minutes, may be longer or short than 30 minutes, or may be, for example, one hour.

The WL execution management server 70 creates a workload execution plan for achieving the power consumption in each time block (hereinafter, referred to as a consumption pattern) determined by the operation plan server 60, and calculates a cost required to achieve the consumption pattern (hereinafter, referred to as a handling cost). The operation plan server 60 and the WL execution management server 70 exchange the consumption pattern and the handling cost, and create an operation plan for maximizing or minimizing an index (for example, a total cost) determined by the DC operator 96.

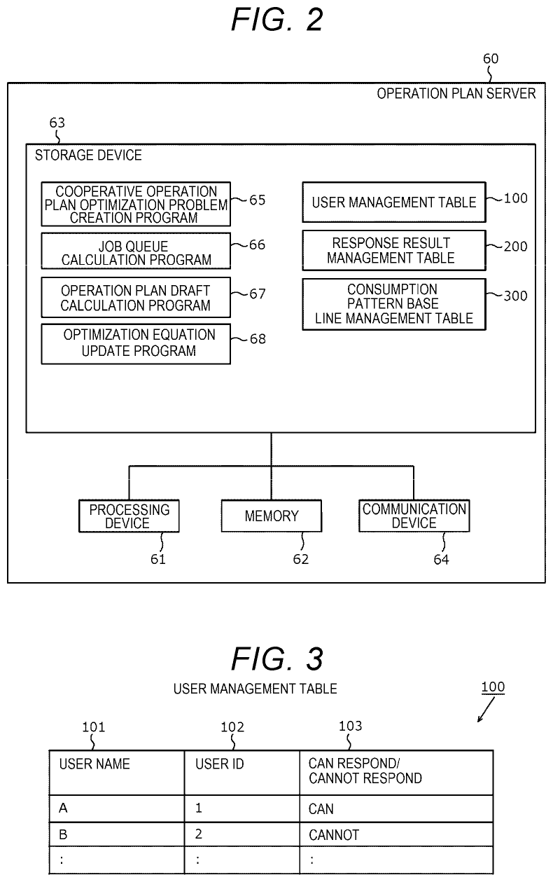

FIG. 2 is a diagram showing an example of hardware provided in the operation plan server 60 and functions thereof. The operation plan server 60 includes a processing device 61, a memory 62, a storage device 63, and a communication device 64. The processing device 61 includes a processor such as a central processing unit (CPU), a digital signal processor (DSP), a graphics processing unit (GPU), and a field-programmable gate array (FPGA), and executes various programs stored in the storage device 63 to perform an operation plan creation method according to the embodiment. The memory 62 is called a main storage device, and includes a read only memory (ROM), a random access memory (RAM), and the like. The storage device 63 is an auxiliary storage device such as a hard disk drive (HDD) or a solid state drive (SSD). The communication device 64 is implemented using a known network interface such as a network interface card (NIC), a wireless communication module, a universal serial interface (USB) module, or a serial communication module.

The storage device 63 of the operation plan server 60 stores programs such as a cooperative operation plan optimization problem creation program 65, a job queue calculation program 66, an operation plan draft calculation program 67, and an optimization equation update program 68. The storage device 63 also stores another program in addition to the programs described here. A DC user management table 100, a response result management table 200, and a consumption pattern base line management table 300 are stored in the storage device 63, and are referred to and updated by each of the programs (65 to 68) executed by the processing device 61.

The cooperative operation plan optimization problem creation program 65 uses the control parameter of each device possessed by the DC operator 96 and the consumption pattern of each DC user 98 as variables to create an optimization problem for maximizing or minimizing an index such as a cost including the handling cost to handle the consumption pattern of each DC user 98. A function implemented by executing the cooperative operation plan optimization problem creation program 65 corresponds to a “cooperative operation plan optimization problem creation unit” in the invention.

The job queue calculation program 66 compares the consumption pattern of the DC user 98 with a corresponding consumption pattern of the user of the data center registered in the consumption pattern base line management table 300, and calculates, in each of the consumption patterns, a lower limit of a power consumption corresponding to an amount of an execution standby job queue in each time block. A function implemented by executing the job queue calculation program 66 corresponds to a “job queue calculation unit” in the invention.

Every time the optimization equation update program 68 receives a consumption pattern and a handling cost from the DC user 98, the optimization equation update program 68 updates an operation plan optimization equation such that a consumption pattern that is achievable by advancing execution of a job queue calculated by the job queue calculation program 66 (hereinafter, referred to as an early execution pattern) is available at a handling cost to handle the early execution pattern. A function implemented by executing the optimization equation update program 68 corresponds to an “optimization equation update unit” in the invention.

The operation plan draft calculation program 67 solves the optimization problem that is created by the cooperative operation plan optimization problem creation program 65 and that is updated by the optimization equation update program 68, and outputs a control plan for the device of the DC operator 96 and a consumption pattern of each DC user 98, which are optimal solutions of the optimization problem. A function implemented by executing the operation plan draft calculation program 67 corresponds to an “operation plan draft calculation unit” in the invention. The operation plan server 60 shown in FIG. 2 may include an input device implemented by a mouse, a keyboard, or the like, and an output device implemented by a liquid crystal display, an organic electro-luminescence (EL) display, or the like.

Next, details of each piece of information stored in the operation plan server 60 will be described.

User Management Table

FIG. 3 is a diagram showing an example of the user management table 100, in which ID information of each DC user 98 and whether the DC user 98 can respond to the operation plan optimization are stored. In the user management table 100, one record includes a name of the DC user 98 (user name 101), identification information of the user (user ID 102), and information 103 indicating whether the DC user 98 specified by the user name 101 and the user ID 102 can respond during creation of the cooperative operation plan. In the example in FIG. 3, it is stored that a user A whose user ID 102 is 1 can respond during creation of the cooperative operation plan, and that a user B whose user ID 102 is 2 cannot respond during creation of the cooperative operation plan.

Response Result Management Table

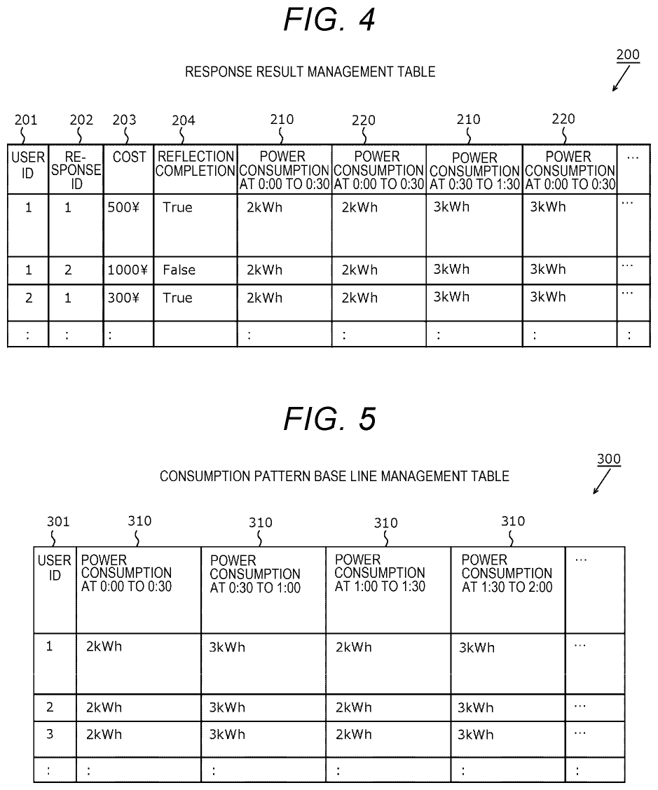

The response result management table 200 is a table in which each response from the WL execution management server and the calculated job queue are stored. FIG. 4 is a diagram showing an example of the response result management table 200. In the response result management table 200, unique identification information is set to a response of each DC user 98 indicated by a user ID 201 (corresponding to the user ID 102 in the user management table 100 in FIG. 3) by which the identification information of the DC user 98 is set. For example, when two responses are obtained from the DC user 98 whose user ID 201 is “1”, “1” and “2” are given as response IDs 202. A handling cost 203 stores a cost required for the response represented by the response ID 202 of the user ID 201. Here, the handling cost 203 stores that the cost for one response is 500 yen or 1,000 yen. A reflection completion flag 204 stores a result of whether the information of the response is reflected in the optimization equation.

A power consumption 210 calculated based on the consumption pattern in the response and a power consumption 220 calculated when the job queue calculated by the job queue calculation program 66 is executed are stored in columns after the reflection completion flag 204. Here, a plurality of columns 210 and 220 are provided according to the divided time period. For example, in a case of leading columns in which the user ID is “1” and the response ID is “1”, it is indicated that the power consumption 210 required to execute a process of the consumption pattern at 0:00 to 0:30 is 2 kWh, and that the power consumption 220 required to execute a process of the job queue within the same time is 2 kWh, and it is indicated that the power consumption 210 required to execute the process of the consumption pattern at 0:30 to 1:30 is 3 kWh, and that the power consumption 220 required to execute the process of the job queue within the same time is 3 kWh.

Similarly, the power consumptions 210 and 220 related to another response ID 202 of the same user ID 201 are also stored. Further, the power consumptions 210 and 220 related to all the response IDs 202 of another user ID 201 are also stored. In a case of the columns in which the user ID 201 is “1” and the response ID 202 is “2”, it is indicated that the power consumptions 210 and 220 are calculated, but the power consumptions 210 and 220 are not reflected since the reflection completion flag 204 is False. In this way, the response result management table 200 includes one or more records each having the items.

Consumption Pattern Base Line Management Table

The consumption pattern base line management table 300 is a table in which ID information of each DC user 98 and whether the DC user 98 can respond to the operation plan optimization are stored. FIG. 5 is a diagram showing an example of the consumption pattern base line management table 300. The consumption pattern base line management table 300 includes one or more records each having items that are a user ID 301 (corresponding to the user ID 102 in user management table 100) by which the identification information of the DC user 98 is set, and a consumption pattern 310 in a workload execution plan in which only convenience of the DC user 98 is taken into consideration. In the consumption pattern base line management table 300, it is indicated that regarding the DC user 98 whose user ID is “1”, the power consumption at 0:00 to 0:30 is 2 kWh, the power consumption at 0:30 to 1:00 is 3 kWh, the power consumption at 1:00 to 1:30 is 2 kWh, and the power consumption at 1:30 to 2:00 is 3 kWh according to a habitual consumption pattern of the DC user 98. In the workload execution plan for the consumption pattern 310, when the execution of the workload becomes possible, the workload may be immediately executed, or the execution of the workload may be delayed by putting the workload in the job queue.

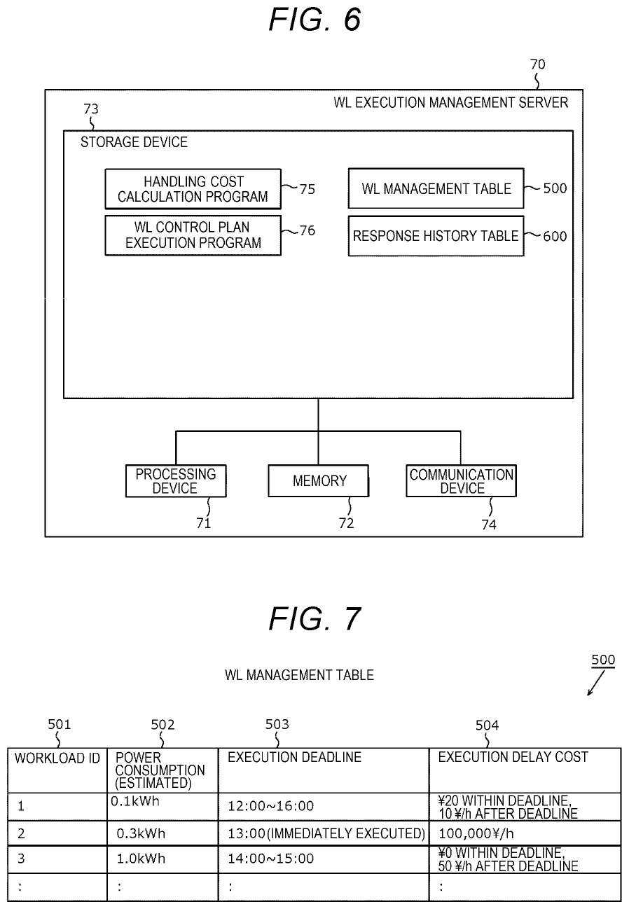

FIG. 6 is a diagram showing an example of hardware provided in the WL execution management server 70 and functions thereof. The WL execution management server 70 includes a processing device 71 (processor) such as a CPU, a DSP, a GPU, or an FPG, a memory (main storage device) 72 such as a ROM or a RAM, a storage device 73 such as an HDD or an SSD, and a communication device 74 including a NIC, a wireless communication module, a USB module, a serial communication module, or the like. The processing device 71 manages the execution of the workload by executing various programs stored in the storage device 73. Although not shown here, the WL execution management server 70 may include an input device such as a mouse or a keyboard and an output device such as a display. The storage device 73 stores a plurality of programs (not shown) such as a handling cost calculation program 75 and a WL control plan execution program 76. In addition, the storage device 73 manages each piece of information such as a WL management table 500 and a response history table 600 to be referred to and changed during the execution of the various programs.

The handling cost calculation program 75 receives a consumption pattern as an input, creates a workload execution plan, and calculates a cost to be paid to the DC user 98 for requesting a change in a workload plan and a job execution plan in order to achieve the consumption pattern. A function implemented by executing the handling cost calculation program 75 corresponds to a “cost calculation unit” in the invention. The WL control plan execution program 76 controls the execution of the workload in real time based on the workload execution plan. The function implemented by executing the WL control plan execution program 76 corresponds to the “WL control plan execution unit” in the invention.

Next, details of each piece of information stored in the WL execution management server 70 will be described.

WL Management Table

The WL management table 500 is a table in which information of each workload is stored. FIG. 7 is a diagram showing an example of the WL management table 500. The WL management table 500 stores a workload ID 501 by which identification information of the workload is set, a power consumption (estimated) 502 of power expected to be consumed when the workload is executed, an execution deadline 503 indicating a deadline for delaying the execution of the workload, and an execution delay cost 504 to be billed to the DC operator 96 according to a loss of the DC user 98 caused by delaying the execution. As shown in FIG. 7, the WL management table 500 includes one or more records identified by the workload ID 501.

As an example, the execution delay cost 504 is represented by a delay cost when the workload is not immediately executed and a delay cost when the execution of the workload is delayed from the execution deadline. The delay cost is a value used in the equation for solving the cooperative operation plan optimization problem, and a unit thereof is yen (Y). The unit is not limited to yen, and may be any other format as long as the unit can be expressed by a monotonically increasing function in which the execution delay cost is defined with respect to an execution time. The records recorded in columns of the WL management table 500 include, in addition to a record of a workload in which information can be previously obtained such as a workload periodically executed or a previously registered workload, a record generated based on prediction for a workload in which accurate workload information cannot be previously obtained such as a workload caused by an access to a website or the like.

Response History Table

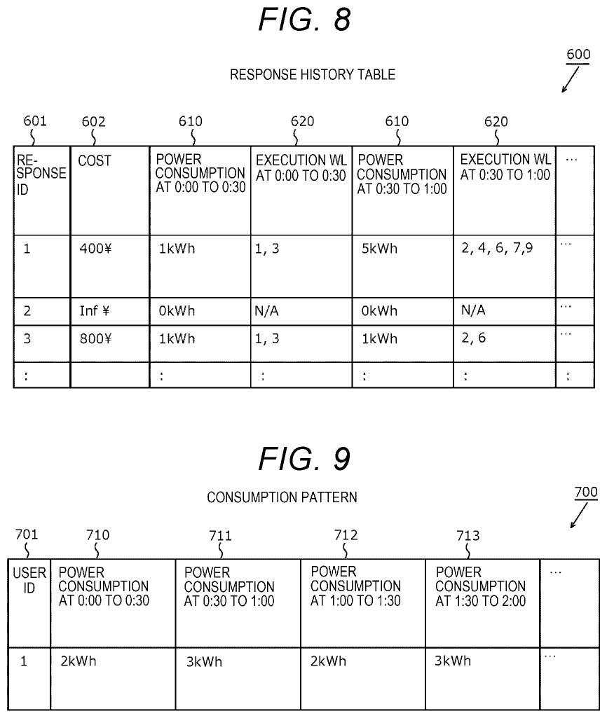

The response history table 600 is a table storing a response transmitted by the workload (WL) execution management server 70 to the operation plan server 60 and an execution plan of the workload in the response. FIG. 8 is a diagram showing an example of the response history table 600. When the WL execution management server 70 transmits the response to the operation plan server 60, unique identification information, that is, a response ID 601 is set for the response. The response history table 600 includes one or more records identified by the response ID 601. Each record includes items that are a handling cost 602 in the response, a power consumption 610 in the response, and an execution WL 620 indicating the workload ID executed in each time block when the power consumption is achieved. For example, the record in which the response ID 601 is “1” indicates that the power consumptions 610 when the WL execution management server 70 changes, with respect to the operation plan server 60, the operation plan as in the execution WL 620 (the execution workload is “1, 3” at 0:00 to 0:30, and the execution workload is “2, 4, 6, 7, 9” at 0:30 to 1:00) are 1 Kwh and 5 Kwh, respectively, and records that the cost 602 to be paid to the DC user 98 for changing the execution plan is 400 yen. Similarly, histories of a plurality of responses are stored in the response history table 600. When the cost in the response ID 601 is displayed as “Inf Y”, it means that the workload cannot be executed since the cost is infinite, the execution workload is stored as “not applicable (N/A)”, and the power consumption 610 is stored as 0 kWh.

The functions of the operation plan server 60 and the WL execution management server 70 described above are implemented by the processing devices 61 and 71 reading the programs stored in the auxiliary storage devices 63 and 73 and executing the programs. The programs described above may be recorded and distributed on a portable recording medium, or may be downloaded from a program distribution server via a network. All or a part of each of the servers 60 and 70 may be implemented by using a virtual information processing resource provided by using a virtualization technique, a process space separation technique, or the like, for example, as in a virtual server provided by a cloud system. All or a part of the functions provided by the information processing devices may be implemented by, for example, a service provided by the cloud system via an application programming interface (API).

Next, an example of the consumption pattern of the DC user 98 will be described using a consumption pattern 700 in FIG. 9. The consumption pattern 700 stores a user ID 701 (corresponding to the user ID 102 in the user management table 100) by which the identification information of the DC user 98 is set, and a power consumption amount of the DC user 98 in each time block of a target time period of the operation plan. Here, the consumption pattern 700 includes the power consumptions 710, 711, 712, 713, and the like in each time block. In FIG. 9, only the power consumptions from 0:00 to 2:00 are shown, but a consumption pattern in a longer time period, preferably 24 hours, is stored. During creation of an operation plan, the consumption pattern 700 is transmitted as an execution workload draft from the operation plan server 60 to the WL execution management server 70, and the WL execution management server 70 returns a handling cost required to achieve the consumption pattern. When the operation plan creation is completed and the consumption pattern of the DC user 98 is determined, the DC user 98 is responsible for the execution of the planned workload in order to achieve the consumption pattern instead of receiving the handling cost from the DC operator 96.

Next, the same view of early execution of a workload and a handling cost will be described. A consumption pattern A corresponding to an early execution pattern of a consumption pattern B means that the consumption pattern A is achieved with respect to a workload execution plan for the consumption pattern B, and that, regarding all workloads, there is a workload execution plan to be executed earlier than an execution time in the workload execution plan for the consumption pattern B. Determination is made using the consumption pattern A, the consumption pattern B, and a job queue in the consumption pattern B. Hereinafter, determination conditions will be described.
(1) In the consumption pattern, a power consumption corresponding to an amount of decrease in the job queue (an amount of workloads extracted from the job queue and executed) is set as a batch job power consumption, and the other is set as an interactive job power consumption. Whether a power consumption of the consumption pattern A exceeds an interactive job power consumption of the consumption pattern B is determined for all the time blocks. Accordingly, it can be confirmed that an interactive job can be executed at the same time in the consumption pattern A.
(2) It is confirmed that for a time t, a “sum of power consumptions from a start time to the time t in the consumption pattern A” is larger than a “sum of power consumptions from a start time to the time t in the consumption pattern B” and smaller than a “sum of power consumptions from the start time to the time t and of a sum in a job queue in the consumption pattern B”. Accordingly, it can be confirmed that a total amount of the workload that can be executed until each time is larger in the consumption pattern A than in the consumption pattern B, and that the consumption pattern A can be achieved by changing an execution time of the workload.

By matching the above conditions (1) and (2), it can be confirmed that the consumption pattern A can be achieved using the workload execution plan for the consumption pattern B by advancing an execution time of a batch job without any change in the execution of the interactive job.

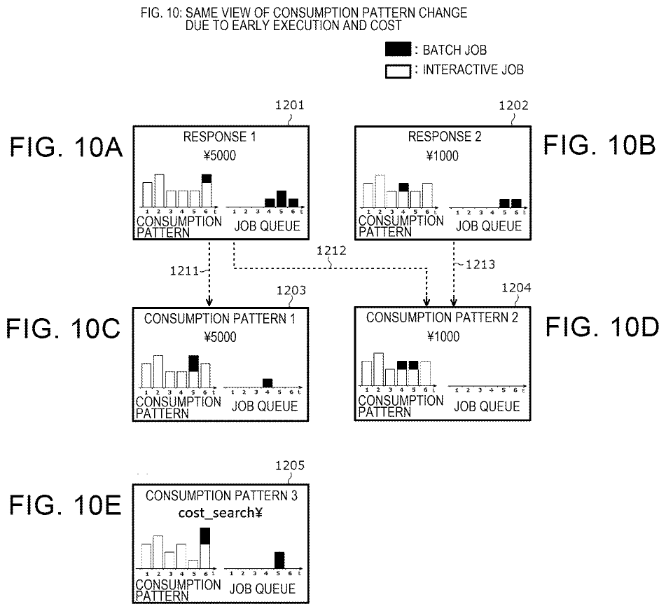

FIGS. 10A to 10E are diagrams showing an example of the same view of a consumption pattern change due to the early execution and the cost. The same view of the determination regarding whether an execution is the early execution and the cost will be described using this example. Horizontal axes representing the consumption pattern and the job queue in frames shown in A to E are time frames. For example, t=1 to 6 indicates intervals each of which is 30 minutes in duration. For example, the time t=1 corresponds to 0:00 to 0:30, the time t=2 corresponds to 0:30 to 1:00, the time t=3 corresponds to 1:00 to 1:30, and similarly, the time t=6 corresponds to 2:30 to 3:00. It is now assumed that the WL execution management server 70 shown in FIG. 1 obtains, from the operation plan server 60 (reference), a consumption pattern and a job queue in a response 1 (1201) and a consumption pattern and a job queue in a response 2 (1202).

A consumption pattern 1 (1203) is a pattern in which a batch job executed at the time t=6 and batch jobs not executed to the end are executed at the time t=5 in the response 1 (1201), which satisfies the conditions (1) and (2). Therefore, as indicated by a dotted line 1211, the consumption pattern 1 (1203) corresponds to an early execution pattern of the response 1 (1201).

Meanwhile, when the response 2 (1202) and the consumption pattern 1 (1203) are compared, the condition (2) is not satisfied, and thus the consumption pattern 1 (1203) does not correspond to an early execution pattern of the response 2 (1202). Actually, when execution of a batch job executed at the time t=4 is not delayed, the consumption pattern 1 cannot be achieved. Here, the consumption pattern 1 (1203) is regarded as the most inexpensive early execution pattern of the response 1 among early execution patterns satisfying the conditions. The consumption pattern 1 (1203) can be executed with a total cost of 5,000 yen which is obtained by adding a cost to be paid to the DC user 98 by the DC operator 96 in order to deal with this and an added amount of the power consumption corresponding to the cost.

A consumption pattern 2 (1204) satisfies the conditions (1) and (2) for both the response 1 (1201) and the response 2 (1202). Here, as indicated by arrows 1212 and 1213, the consumption pattern 2 is regarded as the most inexpensive early execution pattern of the response 2 (1202) among early execution patterns satisfying the conditions, and can be executed at a cost of 1,000 yen.

A consumption pattern 3 (1205) does not satisfy the condition (1) for the response 1 (1201) and the response 2 (1202). Actually, a power consumption at the time t=5 is lower than an interactive job power consumption at the time t=5 in each of the response 1 (1201) and the response 2 (1202), and an interactive job cannot be executed. Therefore, the consumption pattern 3 (1205) does not correspond to the early execution pattern of each of the response 1 (1201) and the response 2 (1202). A base line is not uniquely determined, but is used to check each of the response 1, the response 2, a response 3, and the like. Since the consumption pattern 3 does not satisfy the conditions, the consumption pattern 3 is not in the same view as any response, and is regarded as being able to be executed at a previously defined new search cost (cost_{search}), estimated cost, or the like.

Next, processes executed by the supply-and-demand adjustment server 10, the operation plan server 60, and the WL execution management server 70 during creation of the cooperative operation plan will be described.

First Creation Process for Cooperative Operation Plan

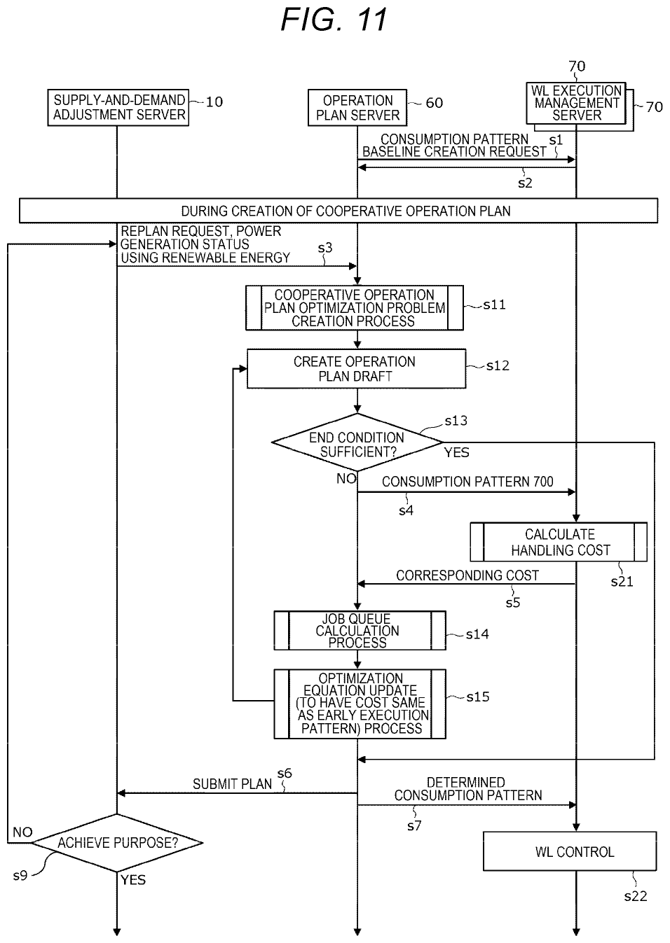

FIG. 11 is a diagram showing an example of the first creation process for the cooperative operation plan. This process is started, for example, at a fixed time interval (for example, at 0:00 every day) or when a related operator makes a request. In this process, the cooperative operation plan is replanned on the data center 20 side in response to a request from the supply-and-demand adjustment server 10 of the power retailer 2. On the data center 20 side that has received the replan request from the supply-and-demand adjustment server 10, the cooperative operation plan is re-created via exchange between the plurality of WL execution management servers 70 and the operation plan server 60.

First, the operation plan server 60 transmits a creation request for a consumption pattern base line to the WL execution management server 70 of each operator (s1). When the WL execution management server 70 receives the creation request, the WL execution management server 70 obtains a power consumption when a workload is executed only in consideration of convenience itself, and transmits the consumption pattern 700 shown in FIG. 9 to the operation plan server 60 (s2). The operation plan server 60 registers the received consumption pattern 700 (see FIG. 9) in the consumption pattern base line management table 300 (see FIG. 2).

Next, when the operation plan server 60 receives a replan request from the supply-and-demand adjustment server 10 (s3), the operation plan server 60 starts a series of operation plan creation processes in cooperation with the WL execution management server 70. Here, examples of the replan request include a demand response request and a change in a power price.

The operation plan server 60 executes a cooperative operation plan optimization problem creation process s11. Here, information includes a control parameter of each device (81, 82, 83, and the like in FIG. 1) possessed by the data center 20, the consumption pattern 700 (see FIG. 9) of each DC user 98, and a variable indicating whether the consumption pattern 700 corresponds to an early execution pattern of each response in the response history table. Using these pieces of information, the operation plan server 60 executes the cooperative operation plan optimization problem creation process s11 of creating an optimization problem for maximizing or minimizing an index such as a cost including a handling cost to handle a consumption pattern of each DC user 98.

The operation plan server 60 solves the optimization problem created in s11, and executes an operation plan draft creation process s12 using an optimal solution. In the operation plan draft creation process s12, whether the consumption pattern corresponds to an early execution pattern of a response in the past or whether the consumption pattern does not correspond to an early execution pattern of any response in the past is output in consideration of a control plan draft for a device used by the DC operator 96 and a consumption pattern of each DC user 98. The early execution pattern can be easily determined by referring to a binary variable introduced in an optimization equation update process s15.

Based on the output of the operation plan draft creation process s12, the operation plan server 60 sequentially determines, for all the users, whether a plan of the DC user 98 can be regarded as the early execution pattern of the response in the past (s13). When a consumption pattern of at least one user does not correspond to the early execution pattern of any response in the past (NO in s13), the operation plan server 60 transmits the consumption pattern 700 of each DC user 98, which is one of the outputs of the operation plan draft creation process s12, to the WL execution management server 70 of the corresponding DC user 98 (s4). At this time, for the DC user 98 whose consumption pattern to be transmitted corresponds to the early execution pattern of the response in the past, a corresponding response ID is transmitted together from the response result management table 200. Thereafter, a series of processes (handling cost calculation) from s21 is executed. On the other hand, when consumption patterns of all the users can be regarded as the early execution patterns of the responses in the past (all are YES in s13), the operation plan server 60 executes a series of processes from s6.

The WL execution management server 70 that has received the consumption pattern 700 from the operation plan server 60 executes the handling cost calculation process s21. In the handling cost calculation process s21, a workload execution plan is created using the consumption pattern 700 (including the response ID) received from the operation plan server 60 as an input, and a handling cost requested by the DC user 98 in order to achieve the consumption pattern is calculated. In addition, the WL execution management server 70 assigns unique identification information to the received consumption pattern 700 and the handling cost calculated in s21, and transmits a response to the operation plan server 60. The operation plan server 60 adds the received content to the response history table 600 (s5).

The operation plan server 60 executes a job queue calculation process s14 on the received consumption pattern of the DC user 98. In the job queue calculation process s14, the consumption pattern of the DC user 98 is compared with a corresponding consumption pattern of the user registered in the consumption pattern base line management table 300 (see FIG. 2), and in each of the consumption patterns, a lower limit of a power consumption corresponding to an amount of an execution standby workload in each time block is calculated. Next, the operation plan server 60 executes the optimization equation update process s15. In the optimization equation update process s15, for each new record registered in the response result management table 200 (see FIG. 2), an operation plan optimization equation is updated such that a consumption pattern that is achievable by advancing execution of the new record (hereinafter, referred to as an early execution pattern) is available at a handling cost to handle the early consumption pattern.

Next, the operation plan server 60 transmits an operation plan that satisfies the end condition to the supply-and-demand adjustment server 10 of the power retailer 2 (s6). The operation plan server 60 transmits, to the WL execution management server 70 of each DC user 98, a determined consumption pattern in the operation plan that satisfies the end condition (s7). The WL execution management server 70 controls the execution of the workload based on the received determined consumption pattern so as to satisfy the determined consumption pattern (s22).

If a purpose of the supply and demand adjustment is satisfied in the received plan (YES in s9), the supply-and-demand adjustment server 10 ends the process, and if the purpose is not satisfied (NO in s9), the supply-and-demand adjustment server 10 returns to s3 for transmitting the replan request again in order to achieve the purpose of the supply and demand adjustment, and causes the processes after s3 to be executed.

Next, the respective processes of s11, s14, s15, and s21 in FIG. 11 will be described in detail.

Cooperative Operation Plan Optimization Problem Creation Process

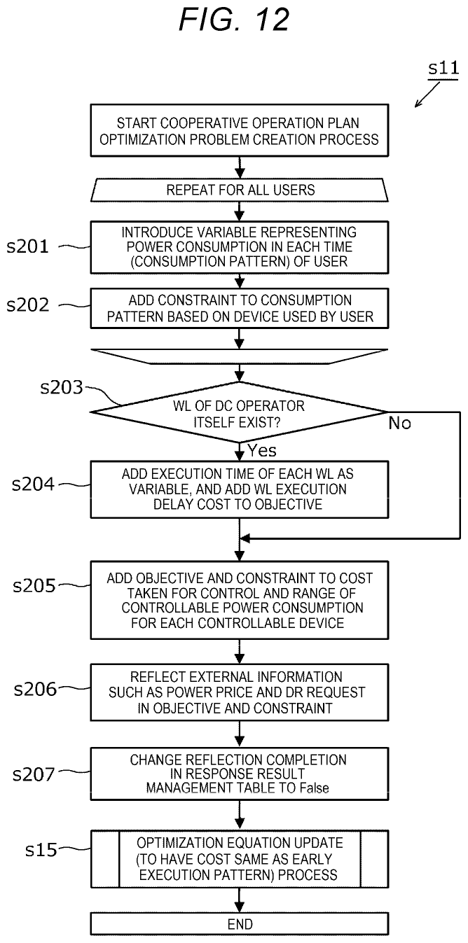

FIG. 12 is a flowchart showing a detailed procedure of the cooperative operation plan optimization problem process s11 shown in FIG. 11. First, the cooperative operation plan optimization problem creation program 65 (see FIG. 2) repeatedly executes the following s201 and s202 with respect to all the DC users 98.

First, in order to handle the consumption pattern of the DC user 98, a variable representing the power consumption in each time block is introduced (s201). A constraint such as an upper limit and a lower limit is added to the introduced variable (s202). The constraint may be set based on a maximum output of the device used by the DC user 98, or may be used when information is provided from the DC user 98. Next, when the DC operator 96 is also the DC user 98, if a workload to be executed by the DC operator 96 itself exists, information of the workload is reflected (s204). In s204, the processing device 61 adds, as a variable, an execution time of the workload from the WL management table 500 of the WL execution management server 70 of the DC operator 96, and adds, to an objective, a WL execution delay cost corresponding to the execution time.

Next, the processing device 61 reflects a possible behavior of each device that is controllable by the DC operator 96 and a cost for the behavior (s205). Variables added here may include a parameter for control such as power ON/OFF of the device in addition to a power consumed by the device in each time block. In the process here, the variables, constraints, and the like can be created in advance based on devices possessed by the data center 20 and can be reflected. Next, the processing device 61 reflects information such as a power price and a DR request received from the supply-and-demand adjustment server 10, adds the constraints to all consumption patterns of the data center 20, and adds the power cost to the objective (s206).

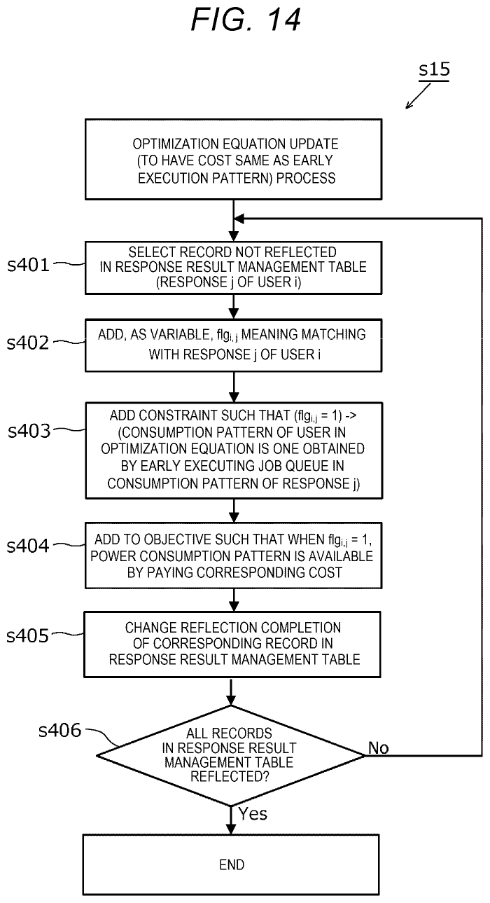

Next, for each record in the response result management table 200, the reflection completion is changed to “False” (s207). Finally, the cooperative operation plan optimization problem creation process ends by executing the optimization equation update (to have same cost as early execution pattern) (s15). The optimization equation update process s15 is the same as s15 shown in FIGS. 11 and s15 described later with reference to FIG. 14. The procedure of the cooperative operation plan optimization problem creation method described here is an example, and the cooperative operation plan optimization problem creation program 65 may create the cooperative operation plan optimization problem, for example, to perform a process of maximizing an index such as a renewable energy utilization rate.

Job Queue Calculation Process

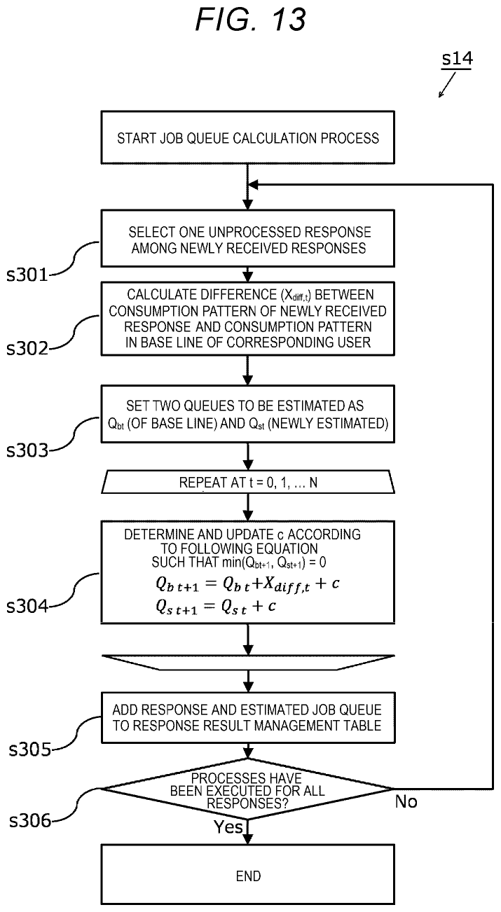

FIG. 13 is a flowchart showing a detailed procedure of the job queue calculation process s14 shown in FIG. 11. The process in FIG. 13 is performed by executing the job queue calculation program 66 shown in FIG. 2 by the processing device 61 of the operation plan server 60. First, the job queue calculation program 66 selects one unprocessed response among newly received responses (s301). Next, the job queue calculation program 66 extracts, from the consumption pattern base line management table 300, a consumption pattern base line of the DC user 98 corresponding to the response selected in s301, and obtains a difference (X_{diff,t}) (s302).

Next, the job queue calculation program 66 calculates a lower limit (Q_{bt}) of a queue in the consumption pattern base line and a lower limit (Qₛₜ) of a queue in the newly received response by repeating the following process in s304 from a time 0 (s303).

c=min(Q_{bt}+X_{diff,t},Qₛₜ)

Q_{bt}+1=Q_{bt}+X_{diff,t}+c and Qₛₜ₊₁=Qₛₜ+c are substituted into the equation (s304). This process corresponds to selecting a pattern in which an amount of a job queue in a newly received response is the smallest, from the following four patterns in total: a change in the consumption pattern is assumed to be caused by any one of two operations, i.e., an operation of delaying execution of a workload and putting the workload in a job queue and an operation of extracting a workload from the job queue and executing the workload at an early stage, and whether the two operations are performed on the base line side or the newly received response side.

Next, a user ID, a response ID, a cost, a consumption pattern, and a calculated job queue of the newly received response are added to the response result management table 200 and the reflection completion flag 204 is set to False (s305). Next, the job queue calculation program 66 confirms whether the processes in s301 to s305 have been executed for all the responses (s306). When the processes in s301 to s305 have been executed for all the responses (Yes in s306), the processing device 61 (see FIG. 2) ends the job queue calculation processing s14. When there is a response that the processes in s301 to s305 are not executed (No in s306), the job queue calculation program 66 returns to the process in s301 to select the response, and repeats the processes in s301 to s306.

Optimization Equation Update Process

FIG. 14 is a flowchart showing a detailed procedure of the optimization equation update process s15 shown in FIG. 11. First, the optimization equation update program 68 shown in FIG. 2 selects, from the response result management table 200, one record whose reflection completion flag 204 is “False” (s401). Next, the optimization equation update program 68 introduces, for the record selected in s401, a binary variable flg_{i,j} for determining whether a consumption pattern of the user ID 301 (see FIG. 5) of the record in the optimization equation corresponds to an early execution pattern of the consumption pattern of the record (s402).

Next, a constraint is added such that a relation is satisfied in which when flg_{i,j}=1, the consumption pattern of the user ID of the record in the optimization equation is the early execution pattern of the consumption pattern of the record based on the consumption pattern and a job queue of the record (s403). As an example, the following processes are executed.
(1) In the consumption pattern of the record, a power consumption corresponding to an amount of decrease in the job queue (an amount of workloads extracted from the job queue and executed) is set as a batch job power consumption, and the other is set as an interactive job power consumption. A constraint is added in which the “consumption pattern in the optimization equation” at each time is larger than “interactive job power consumption*flg_{i,j}”. Here, “*” is a symbol indicating multiplication.
(2) A constraint is added in which for all times, a “sum in the consumption pattern in the optimization equation up to a time” is larger than a “sum in the consumption pattern of the record up to the time*flg_{i,j}”.

By executing the above, it is possible to perform the satisfaction determination in FIGS. 10A to 10E.

Next, addition is made to the objective such that when flg_{i,j}=1, the consumption pattern is available by paying a handling cost (s404). As an example, the following processes are executed.
(a) “cost*flg_{i,j}” is added to the objective by using the cost of the record as “cost”.
(b) When a binary variable flgᵢ indicating that the user ID of the record does not correspond the early execution pattern of the consumption pattern of any response is not introduced, “cost_{search}*flgᵢ” is added to the objective by introducing flgᵢ and using a new search cost as “cost_{search}”.
(c) With respect to the user ID of the record, a constraint in which a “sum of related flags”=1 is added such that the associated flag is just one.

By executing the above, the cost of each consumption pattern in FIGS. 10A to 10E is obtained.

Next, the reflection completion flag 204 of the record in the response result management table 200 is changed to True (s405). Next, the optimization equation update program 68 confirms whether all the records in the response result management table 200 are reflected. If all the records are reflected (Yes in s406), the optimization equation update process s15 ends. If there is a record not reflected (No in s406), the optimization equation update program 68 repeats the processes in s401 in which the record is selected to s405. The optimization equation update method described here is an example, and the optimization equation update program 68 may add a constraint and an objective so as to produce similar effects. The new search cost described here is an example, and may be one that uses a constant defined in advance as in the example, one that changes according to the number of responses, or one that is estimated according to a record in the response result management table 200.

Handling cost Calculation Process

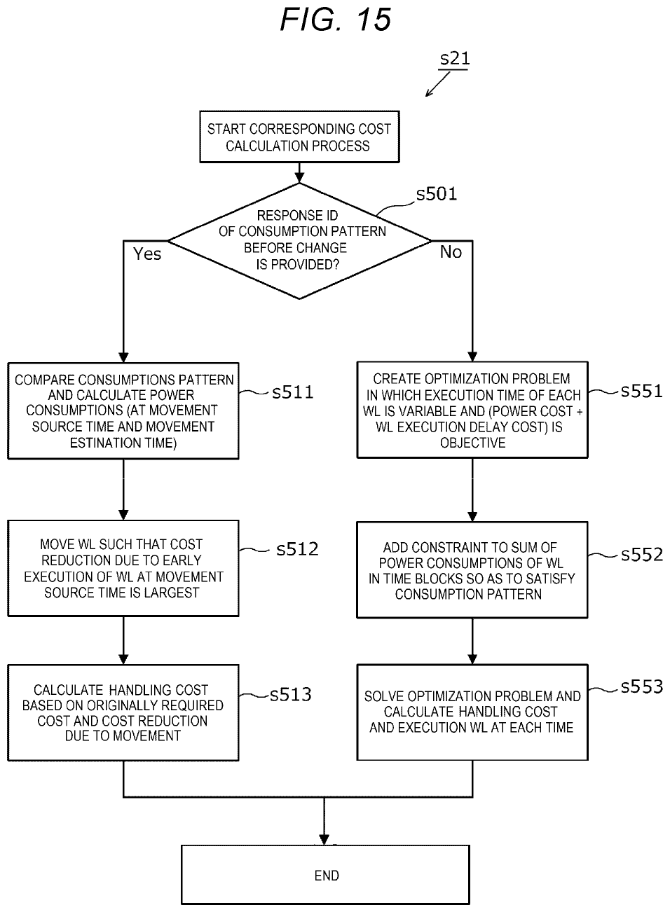

FIG. 15 is a flowchart showing details of the handling cost calculation process s21. First, the handling cost calculation program 75 determines whether information on whether a received consumption pattern is an early execution pattern of a past response is provided (s501). When a response ID whose consumption pattern is the early execution pattern is provided (Yes in s501), processes in s511 and thereafter are executed in order to simply calculate a cost. When the response ID is not provided (No in s501), processes in s551 and thereafter are executed in order to create a workload execution plan for the consumption pattern.

Next, a series of processes in s511 to s513 will be described. When the response ID is provided, the handling cost calculation program 75 shown in FIG. 6 extracts a record of the corresponding response ID 601 from the response history table 600 (see FIG. 8), and compares the consumption patterns to calculate the power consumptions (at a movement source time and a movement destination time) (s511). Next, a batch job having the largest cost reduction due to execution at the movement destination time among batch jobs at the movement source time is obtained, and the batch job is moved (s512). Finally, the handling cost is calculated based on a sum of a change amount of cost due to the movement of the batch job in s512 and the cost 602 of the corresponding record in the response history table 600, and the process ends (s513).

Next, a series in processes in s551 to s553 will be described. When the response ID is not provided, the handling cost calculation program 75 performs optimization of the workload execution plan. The handling cost calculation program 75 adds an execution time of each workload as a variable from the WL management table 500 shown in FIG. 7, and adds, to the objective, a power cost based on the execution delay cost 504 corresponding to the execution deadline 503 (s551). Next, the handling cost calculation program 75 adds a constraint to a sum of the power consumptions of the execution WLs in the time blocks so as to satisfy the consumption pattern (s552). Finally, the handling cost calculation program 75 solves the created optimization problem, and acquires a handling cost as an optimal solution and the execution WL in each time block as an optimal solution (s553). At this time, when an executable solution is not found, a handling cost “inf” is acquired with the intention that it is impossible to handle the consumption pattern. The handling cost calculation method described here is an example, and the handling cost calculation program 75 may be any program as long as the handling cost and the workload execution plan are obtained. For example, the method may be a method of calculating the handling cost in consideration of an index such as a renewable energy utilization rate, or may be a method not dependent on optimization.

Management Screen to DC Operator

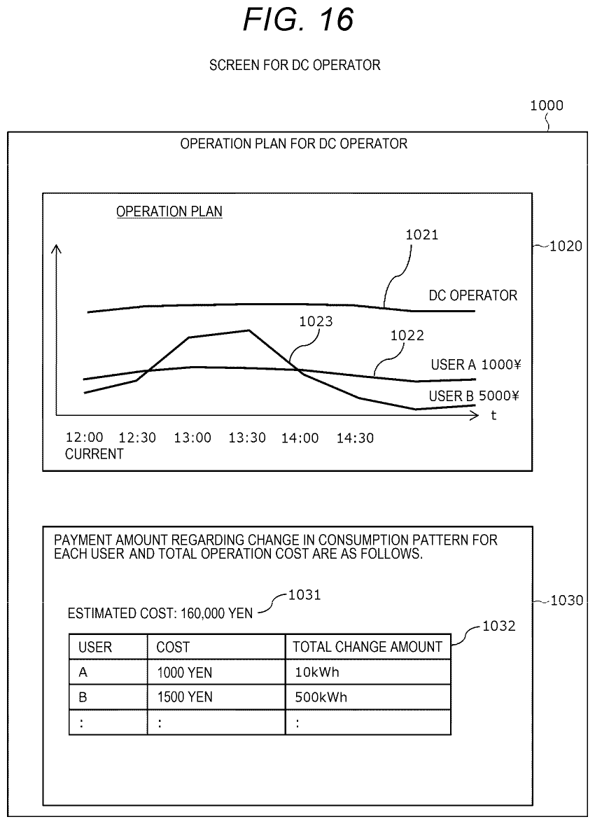

FIG. 16 is a diagram showing an example of a management screen for the DC operator 96 displayed on the DC operator terminal 95 (see FIG. 1). A DC operator management screen 1000 includes a consumption pattern display field 1020 of each DC user 98 for a created workload execution plan, and a cost display field 1030 of a cost for executing the plan. Consumption patterns 1021 to 1023 of the DC operator 96 and the DC users 98 in a current operation plan are displayed in the consumption pattern display field 1020. A horizontal axis represents time, and a vertical axis represents cost (unit: Y). A total sum 1031 obtained by adding a total sum of the handling costs to the DC users, a control cost of the DC operator, and a power cost, the handling cost for each DC user 98, and a change amount 1032 from a consumption pattern base line are displayed in the cost display field 1030.

Management Screen to DC User

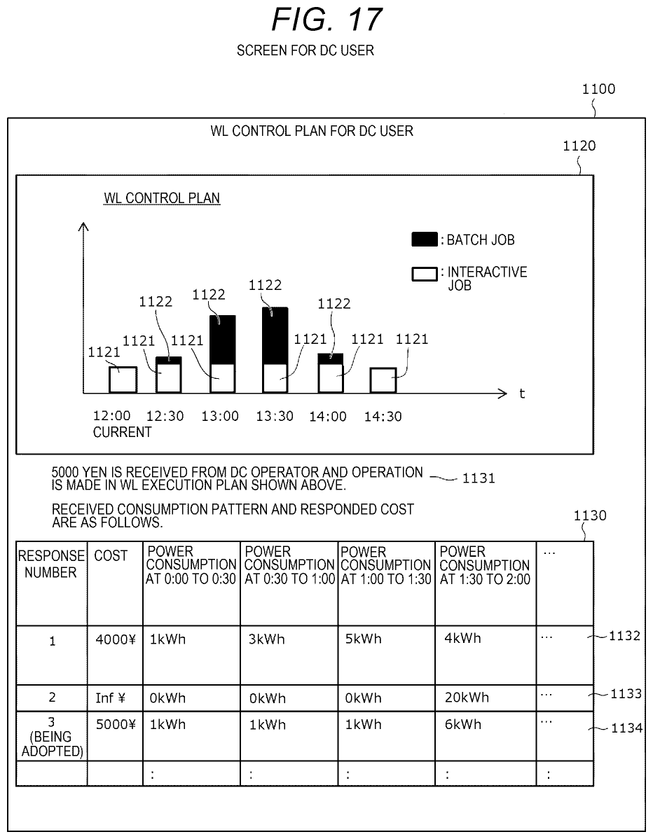

FIG. 17 is a diagram showing an example of a management screen for the DC user 98 displayed on the DC user terminal 97 (see FIG. 1). A DC user management screen 1100 includes a workload (WL) execution plan display field 1120 for a created plan and a response history display field 1130 during plan creation. An interactive job execution amount 1121 and a batch job execution amount 1122 in each time block in a current workload execution plan are displayed in the WL execution plan display field 1120. A vertical axis represents an amount of a job to be executed, and a horizontal axis represents a time period in which the operation plan is created. Here, the horizontal axis is six blocks obtained by dividing the time from 12:00 to 15:00 every 30 minutes.

In FIG. 17, an interactive job is indicated by a white bar graph, and a batch job is indicated by a black bar graph on the interactive job. The vertical axis is a power (kWh) required to execute the job. Here, it is possible to read that the batch jobs are executed during a time from 12:30 to 14:30, and in particular, an amount of the batch jobs scheduled to be executed is large at 13:00 to 14:00.

A handling cost 1131 received from the DC operator for the current workload execution plan, and a list 1132 of a consumption pattern presented during cooperative operation plan creation and a handling cost calculated for the consumption pattern are displayed in the response history display field 1130. Here, it is indicated that the consumption patterns indicated by numbers 1 to 3 are received when the optimal cooperative operation plan is created, and the consumption pattern indicated in a third record 1134 shown at the lowest end is adopted. The handling cost ¥5,000 shown in the record 1134 is displayed in the handling cost 1131.

Second Creation Process for Renewable Energy Procurement Plan

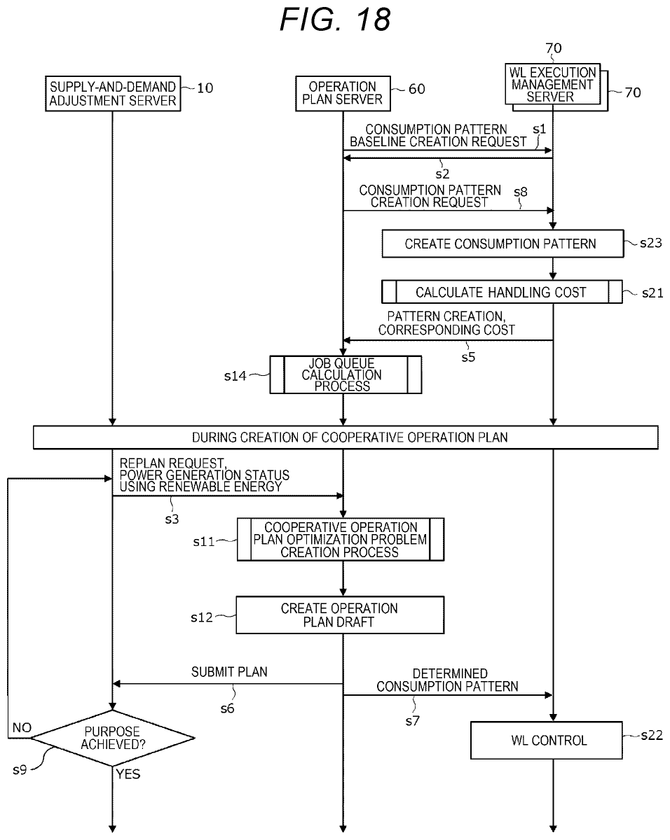

FIG. 18 is a diagram showing an example of the second creation process for the cooperative operation plan. This process is started, for example, at a fixed time interval (for example, at 0:00 every day) or when a related operator makes a request.

First, the operation plan server 60 transmits a creation request for a consumption pattern base line to the WL execution management server 70 of each operator (s1). When the WL execution management server 70 receives the creation request, the WL execution management server 70 transmits, to the operation plan server 60, the consumption pattern 700 in which a workload is executed only in consideration of convenience itself (s2). The operation plan server 60 registers the received consumption pattern in the consumption pattern base line management table 300 shown in FIG. 5.

Next, the operation plan server 60 transmits a creation request for a consumption pattern change draft to the WL execution management server 70 of each operator (s8). When the WL execution management server 70 receives the creation request, the WL execution management server 70 generates a plurality of possible consumption patterns based on its own WL management table 500 (see FIG. 6) (s23). As an example, the consumption patterns can be generated when each workload is allocated within an execution deadline of the workload.

Next, the WL execution management server 70 creates a workload execution plan by using each consumption pattern generated in s23 as an input, and executes the handling cost calculation process s21 of calculating a handling cost requested by the DC user in order to achieve the consumption pattern. The handling cost calculation process s21 is executed according to the procedure shown in FIG. 15. The WL execution management server 70 assigns unique identification information to the consumption pattern and the handling cost calculated in s21, transmits a response to the operation plan server 60, and at the same time, the information is added to the response history table 600 (see FIG. 6) (s5).

Next, the operation plan server 60 that has received the response from the WL execution management server 70 executes the job queue calculation process (s14). The job queue calculation process (s14) is executed according to the procedure shown in FIG. 13. As described above, the workload execution plan is created and the job is executed according to the plan, but when it is necessary to replan the workload execution plan due to a cooperative operation, the supply-and-demand adjustment server 10 requests each operation plan server 60 to replan the workload execution plan (s3).

When the operation plan server 60 receives the replan request from the supply-and-demand adjustment server 10 (s3), the operation plan server 60 starts a series of operation plan creation processes in cooperation with the WL execution management server 70. Here, examples of the replan request include a demand response request and a review request accompanying a change in the power price. The operation plan server 60 executes a cooperative operation plan optimization problem creation process s11 of creating an optimization problem that includes, as variables, the control parameter of the device possessed by the DC operator 96, the consumption pattern of the DC user 98, and whether the consumption pattern corresponds to an early execution pattern of a response in the response history table 600 (see FIG. 8), and that is used for maximizing or minimizing an index such as a cost including a handling cost of the consumption pattern of the DC user 98. The cooperative operation plan optimization problem creation process s11 is executed according to the procedure shown in the flowchart in FIG. 12.

The operation plan server 60 solves the optimization problem created in s11, and executes the operation plan draft creation process s12 that outputs, as optimal solutions, a control plan draft for the device used by the DC operator 96, a consumption pattern of each DC user 98, and whether the consumption pattern corresponds to an early execution pattern of a response in the past or whether the consumption pattern does not correspond to an early execution pattern of any response in the past. However, in the Second Creation Process for Renewable Energy Procurement Plan, since the new search is not performed during replan, cost_{search} is set to inf, and the execution pattern is forced to correspond to an early execution pattern of a response in the past.

The operation plan server 60 transmits the operation plan that satisfies the end conditions to the supply-and-demand adjustment server 10 (s6), and transmits, to the WL execution management server 70 of each DC user 98, a determined consumption pattern in the operation plan that satisfies the end condition (s7). If a purpose of the supply and demand adjustment is satisfied in the received operation plan (YES in s9), the supply-and-demand adjustment server 10 ends the process, and if the purpose is not satisfied (NO in s9), the supply-and-demand adjustment server 10 returns to s3 for transmitting the replan request again in order to achieve the purpose of the supply and demand adjustment, and causes the processes after s3 to be executed. Each WL execution management server 70 controls the execution of the workload based on the determined consumption pattern received in s7 so as to satisfy the consumption pattern (s22).

As described above, according to the embodiment of the invention, it is easy to perform the power interchange between the DC operators 96, for example, in a case of the supply and the demand does not coincide with each other due to introduction of the renewable energy. Also for a user company (DC user 98), an operation plan can be created in accordance with an external factor such as a renewable energy supply amount. When optimization of the operation plan is performed, on the DC operator 96 side, a change in the consumption pattern is proposed while estimating how much the user company (DC user 98) can change the operation plan, and thus the number of times of turning the loop of the adjustment of the consumption pattern and the cost can be reduced between the DC operator 96 and the DC user 98.

The invention is not limited to the above embodiments, and can be implemented by using any component within a range not departing from the gist of the invention. The embodiments and modifications described above are merely examples, and the invention is not limited to these contents as long as the features of the invention are not impaired. A part of the functions included in the devices of the embodiment may be provided in other devices, and the functions included in other devices may be provided in a same device. Further, the configuration of the program described in the embodiment is an example, and for example, a part of the program may be embedded in another program, or a plurality of programs may be implemented as one program.

1. An operation plan creation device in a data center, the data center including a plurality of server devices each configured to execute a workload of a user, workload execution management servers respectively provided in the server devices, and an operation plan server connected to the workload execution management servers, wherein
each of the workload execution management servers manages execution of the workload of the user and includes a cost calculation unit configured to calculate a handling cost to handle a given consumption pattern, and
the operation plan server includes
a cooperative operation plan optimization problem creation unit configured to create an optimization problem for maximizing or minimizing an index of the handling cost in consideration of a consumption pattern of the user,
an optimization equation update unit configured to update an operation plan optimization equation such that a consumption pattern obtained by changing a consumption pattern in a past response history of the user according to a certain rule is available at a handling cost to handle the changed consumption pattern, and
an operation plan draft calculation unit configured to create, by obtaining a solution of the updated operation plan optimization equation, an operation plan draft for the consumption pattern of the user and a device held by a data center operator.

2. The operation plan creation device according to claim 1, wherein
the operation plan server further includes a job queue calculation unit configured to compare the consumption pattern of the user with a corresponding consumption pattern base line of the user registered in advance, and calculate, in each of the consumption patterns, a lower limit of a power consumption corresponding to an amount of an execution standby job queue in each time block, and
every time the optimization equation update unit receives a consumption pattern and a handling cost from the user, the optimization equation update unit updates the operation plan optimization equation such that a pattern that is achievable by advancing execution of a job queue calculated based on the consumption pattern is available as an early execution pattern at a handling cost to handle the early execution pattern.

3. The operation plan creation device according to claim 2, wherein
the operation plan server includes a management table in which workload information of the user and prediction information thereof are stored, and
the cooperative operation plan optimization problem creation unit evaluates a cost due to execution delay of a workload and a required energy cost of a consumption pattern presented by the data center operator, and calculates a required cost correspondingly.

4. The operation plan creation device according to claim 3, wherein
when the consumption pattern of the user calculated by the operation plan draft calculation unit is an early execution pattern of a consumption pattern that responds in the past, calculation in the cost calculation unit is simplified by providing the corresponding consumption pattern and calculated job queue to the workload execution management server.

5. The operation plan creation device according to claim 4, wherein
the cooperative operation plan optimization problem creation unit optimizes a power interchange plan according to a request from a power retailer that includes a supply-and-demand adjustment server for planning a power interchange among the data center, another data center service operator, and another distributed energy resource operator, and
during execution of the optimization, an operation plan in the data center is re-created repeatedly until an end condition for achieving adjustment of the power interchange is satisfied.

6. The operation plan creation device according to claim 2, wherein
the workload execution management server includes a workload control plan execution unit configured to control the execution of the workload of the user based on the operation plan.

7. The operation plan creation device according to claim 6, wherein
in a case in which the cost calculation unit of the user is not available or a response speed thereof is not sufficient when a replan is requested from the operation plan server, the operation plan draft calculation unit
creates, based on a plurality of consumption patterns registered in advance and handling costs thereof, an optimal operation plan draft by setting, as a search range, only a consumption pattern that is achievable by early executing a calculated job queue in the registered consumption patterns.

8. An operation plan creation method in a data center, the data center including a plurality of server devices each configured to execute a workload of a user, workload execution management servers respectively provided in the server devices, and an operation plan server connected to the workload execution management servers, wherein
when an operation plan of a created workload is to be created or changed, the operation plan server
calculates a consumption pattern of each user of the server device and a handling cost thereof,
creates an operation plan optimization equation for maximizing or minimizing an index of the handling cost in consideration of a consumption pattern of the user of the server device,
updates the operation plan optimization equation such that a consumption pattern obtained by changing a consumption pattern in a past response history of the user according to a certain rule is available at a handling cost to handle the changed consumption pattern, and
creates, by obtaining a solution of the updated operation plan optimization equation, an operation plan for the consumption pattern of the user and a device held by a data center operator.

9. The operation plan creation method according to claim 8, wherein
the workload execution management server
compares the consumption pattern of the user with a corresponding consumption pattern base line of the user registered in advance, and
calculates, in each consumption pattern, a lower limit of a power consumption corresponding to an amount of an execution standby job queue in each time block, and transmits the calculated lower limit to the operation plan server, and
every time the operation plan server receives a consumption pattern and a handling cost from the workload execution management server, the operation plan server updates the operation plan optimization equation such that an early execution consumption pattern that is achievable by advancing execution of a job queue calculated based on the consumption pattern of the user is available at a handling cost to handle the pattern.

10. The operation plan creation method according to claim 9, wherein
the workload execution management server stores workload information of the user and prediction information thereof, evaluates a cost due to execution delay of a workload and a required energy cost of a consumption pattern presented by the operation plan server, calculates a required cost correspondingly, and presents the early execution consumption pattern to the operation plan server.

11. The operation plan creation method according to claim 10, wherein
when the consumption pattern of the user calculated by the operation plan server is an early execution pattern of a consumption pattern that responds in the past, handling cost calculation is simplified by providing the corresponding consumption pattern and calculated job queue to the workload execution management server.

12. The operation plan creation method according to claim 11, wherein
the operation plan server
optimizes a power interchange plan according to a request from a power retailer that includes a supply-and-demand adjustment server for planning a power interchange among the data center, another data center service operator, and another distributed energy resource operator,
sequentially transmits the optimized power interchange plan to the plurality of workload execution management servers,
receives handling costs from the plurality of workload execution management servers and minimizes the handling costs, and
re-creates repeatedly an operation plan in the data center until an end condition for achieving adjustment of the power interchange is satisfied.

13. The operation plan creation method according to claim 12, wherein
the workload execution management server controls execution of the workload of the user based on the operation plan.

14. The operation plan creation method according to claim 13, wherein
in a case in which the cost calculation unit of the user is not available or a response speed thereof is not sufficient when a replan is requested from the operation plan server, an optimal operation plan is created, based on a plurality of consumption patterns registered in advance and handling costs thereof, by setting, as a search range, only a consumption pattern that is achievable by early executing a calculated job queue in the registered consumption patterns.

15. An operation plan optimization system in a data center, comprising:
the operation plan creation device according to claim 1; and
a plan viewing server connected to the operation plan creation device via a network, wherein
the plan viewing server provides the operation plan created by the operation plan creation device according to a request from the user via the network, and receives an input on the operation plan from the user.
